(19) United States
(12) Patent Application Publication
(10) Pub. No.: US 2009/0135305 A1
(43) Pub. Date: May 28, 2009

(54) Video System for a Splicing Device and Method for Operating a Video System for a Splicing Device

(76) Inventors: Christian Heidler, Munchen (DE); Rainer Matthias Kossat, Aschau (DE); Johann Simon Daniel Hess, Munchen (DE); Jurgen Kilb, Mainz-Kastel (DE); Martin Klahr, Bad Kreuznach (DE)

Correspondence Address: CORNING INCORPORATED, INTELLECTUAL PROPERTY DEPARTMENT, SP-TI-3-1, CORNING, NY, 14831, US

(21) Appl. No.: 12/339,200

(22) Filed: Dec. 19, 2008

Related U.S. Application Data
(63) Continuation of application No. PCT/EP2007/005449, filed on Jun. 20, 2007.

(30) Foreign Application Priority Data
Jun. 22, 2006 (DE) DE102006028693.6

(51) Int. Cl. H04N 5/222

(52) U.S. Cl. 348/722; 348/E05.022

(57) ABSTRACT

A video system for a splicing device comprises a processor with a camera interface integrated on chip, a first and a second camera and also a selection device. The selection device has an interface output, which is coupled to the camera interface, and also a first interface input, which is coupled to the first camera, a second interface input, which is coupled to the second camera, and a control input for feeding in a selection signal. The first or the second interface input can be coupled to the interface output depending on the selection signal. Via the on-chip camera interface, it is possible both to receive image data and to output control signals for controlling functions of a camera respectively connected via the selection device.

### RELATED APPLICATIONS

This application is a continuation of International Application No. PCT/EP2007/005449, filed Jun. 20, 2007, which claims priority to German Application No. DE102006028693.6, filed Jun. 22, 2006, both applications being incorporated herein by reference.

### FIELD OF THE INVENTION

The invention relates to a video system for a splicing device, and to a method for operating a video system for a splicing device. The invention furthermore relates to a use of the video system.

### TECHNICAL BACKGROUND

In a splicing device, optical waveguides such as fiber-optic cables, for example, can be spliced, that is to say connected to one another. The splicing device aligns the two ends of the optical fibers to be spliced with respect to one another and fuses them thermally, for example by arc welding. For adjusting the optical fibers, inter alia, video systems comprising one or a plurality of cameras are used in splicing devices. For this purpose, it is possible to use complementary metal oxide semiconductor (CMOS) cameras, wherein image data are present in digital form, or else charge coupled device (CCD) cameras. If a camera supplies an analog image signal, the latter is generally converted into a digital image format by means of an analog-to-digital converter.

The image data of the cameras can be evaluated in a microprocessor in order for example to perform an adjustment of the optical fibers. In this case, two or more cameras can be used in order to ensure a positioning of three coordinate axes.

The cameras are generally connected to the microprocessor via a programmable logic such as a programmable logic device, PLD, or a field programmable gate array, FPGA. In this case, the programmable logic has the task of ensuring timing, of buffer-storing the image data and of enabling access to lines and columns of the image data. In addition, special camera functions can also be controlled, inter alia.

An FPGA for a video system is addressed for example via a 16 bit wide data bus and a 24 bit wide address bus. In a manner similar to that in the case of a microcontroller, commands for driving an FPGA can be stored in a memory from where they are transferred to the FPGA as required. Such an FPGA or a comparable programmable logic requires a relatively high number of lines having a correspondingly large space requirement for example on a circuit board. Furthermore, for the processing of the image data it is necessary to provide clock generation for the programmable logic, in accordance with synchronization signals of the cameras. However, the additional clock signals usually adversely affect the electromagnetic compatibility, EMC, and increase the circuitry outlay.

### SUMMARY

The disclosure is directed to a video system for a splicing device and a method for operating the video system wherein image data for a plurality of cameras can be processed with reduced circuitry outlay. In one embodiment of the invention, a video system for a splicing device comprises a processor with a camera interface integrated on chip. Furthermore, a first and a second camera are provided. A selection device has an interface output, which is coupled to the camera interface, and also a first interface input, which is coupled to the first camera, a second interface input, which is coupled to the second camera, and a control input for feeding in a selection signal. The first or the second interface input can be coupled to the interface output depending on the selection signal. Via the on-chip camera interface, it is possible both to receive image data and to output control signals for controlling functions of a camera respectively connected via the selection device.

The circuitry outlay of the video system for a splicing device can be significantly reduced through the provision of a special processor with a camera interface integrated on chip and a selection device that can be realized in a simple manner.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operation of the invention.

### BRIEF DESCRIPTION OF THE FIGURES

FIG. 1 shows an exemplary embodiment of a video system according to the disclosure,

FIG. 2 shows an exemplary embodiment of a selection device of FIG. 1,

FIG. 3 shows an exemplary block diagram of a selection device with connected cameras according to one embodiment,

FIG. 4 shows an exemplary block diagram of a selection device with cameras and illumination sources according to another embodiment,

FIG. 5 shows an exemplary embodiment of a conventional camera arrangement with illumination sources,

FIG. 6a shows a first exemplary illustration of an illuminated optical fiber,

FIG. 6b shows a second exemplary illustration of an illuminated optical fiber,

FIG. 7 shows an exemplary embodiment of a camera arrangement with illumination sources according to one embodiment, and

FIG. 8 shows an exemplary signal-time diagram for a control of illumination sources.

### DETAILED DESCRIPTION OF THE INVENTION

Reference will now be made in detail to the preferred embodiments of the present invention, examples of which are illustrated in the accompanying drawings. Whenever possible, like reference numbers will be used to refer to like components or parts.

FIG. 1 shows an exemplary embodiment of a video system for a splicing device. A processor 1, a selection device 2 and also a first and a second camera 3, 4 are provided in this case. The camera 3 is connected by a connection 31 to a first interface input 21 of the selection device 2. The camera 4 is equally coupled by a connection 41 to a second interface input 22 of the selection device 2. An interface output 29 of the selection device 2 is connected to a camera interface 11 of the processor 1, said camera interface being integrated on chip. In the exemplary embodiment, the connection lines of the cameras 3, 4 and of the processor 1 to the selection device 2 are embodied as a data bus having a plurality of parallel data lines.

A selection signal can be fed in via a control input 28 of the selection device 2, depending on which selection signal alternatively the first interface input 21 or the second interface input 22 is coupled to the interface output 29. As a result, in this exemplary embodiment, either the connection 31 of the first camera 3 or the connection 41 of the second camera 4 is coupled to the camera interface 11 of the processor 1. The selection signal can also be generated by the processor 1.

Image data CAM can be received via the camera interface 11. This can be effected in digital form, for example, such that the image data CAM in digitized form are read into the processor. If image signals CAM are present in analog form, they can be converted into a digitized form by means of an analog-to-digital converter, for example, before they are fed to the camera interface 11. As an alternative, the processor 1 has a camera interface 11 having an analog input for analog image signals CAM.

Via the camera interface 11 integrated on chip, it is also possible to output control signals CTRL for controlling a camera 3, 4 respectively coupled to the camera interface 11 via the selection device 2. Functions of the connected camera can be accessed by means of the control signals CTRL. By way of example, sensitivity, shutter times, sharpness or other functions can be set. By means of the control signals CTRL it is likewise possible to select an image excerpt that is to be transmitted as an image signal, to perform a mirroring or a rotation of the image excerpt in the camera, or else to instigate a white balancing in the camera. A plurality of data lines can also be provided for the control signals CTRL. By way of example, four data lines are provided for the controls signals CTRL and ten data lines are provided for the image signals CAM.

The cameras 3, 4 can be embodied as CMOS cameras, for example, or alternatively as CCD cameras. It is also possible to use cameras with other technologies, as long as a respective image signal can be output in a format suitable for the camera interface 11 or can be converted into the suitable format. The processor 1 used can be an XScale® processor from Intel® for example, which has a corresponding camera interface 11 on chip. Apart from that the operating system is implemented on the processor 1, which operating system can provide a graphical user interface with menus and screen messages, inter alia. Furthermore, a control program for the splicing process and also a program for various calculations, control tasks and regulating tasks run on the processor 1.

The processor 1 can be a monolithically integrated component in which the camera interface 11 and the processor are jointly integrated on the same chip. In this case, the selection device 2 can be arranged outside the processor, for example on a further chip. Alternatively, a processor 1 in which the selection device 2 is integrated into the processor 1 can be provided.

By way of example, the processor 1 including, for example, its various registers, its arithmetic unit or arithmetic logic unit (ALU), its control unit and its memory manager together with the camera interface 11 are integrated monolithically on a single semiconductor component. This semiconductor component can be incorporated into a processor housing with corresponding connections or connection pins. By way of example, the camera interface 11 integrated on chip is joined via corresponding connection lines or other electrical connections to one or a plurality of assigned connection pins of the processing housing, which can be connected to a printed circuit board.

Via the on-chip camera interface, it is possible both to receive image data and to output control signals for controlling functions of a camera. The interface can be embodied not only as a parallel interface having a plurality of data lines for transmitting image signals and control signals, but also as a serial interface. Image data received via the camera interface 11 can be stored in a main memory of the processor 1.

For the case where the cameras 3, 4 supply digital image signals, that is to say image signals in digital form, the cameras 3, 4 or the selection device 2 can be connected directly to a digitally embodied camera interface 11. Thus, by way of example, the interface output 29 of the selection device 2 can be electrically connected to the camera interface 11 via a cable connection or a connection on a printed circuit board. By way of example, the interposition of assemblies for converting image signals from one format into another or the interposition of buffer memories for image data can thus be dispensed with.

In the case where analog image signals are present from the cameras 3, 4, a respective analog-to-digital converter for converting analog image signals into digital image signals can be provided outside the processor 1 and the camera interface 11 which is embodied digitally in this case. By way of example, the analog-to-digital converter is arranged outside the processor housing.

Alternatively, an analog-to-digital converter together with the assemblies of the processor 1, in particular the camera interface 11, can be monolithically integrated on a semiconductor component. In this case, the camera interface 11 is embodied as an analog interface, for example, which is electrically connected to connection pins of the processing housing. The selection device 2 or corresponding cameras can in turn be directly connected to said analog camera interface 11 or the corresponding connection pins, for example via a cable connection or a connection on a printed circuit board.

In a use of the video system according to the invention in a positioning system for optical fibers in a splicing device, the cameras 3, 4 are provided for observing the fibers to be spliced. This serves, inter alia, for correspondingly aligning the fibers before the actual splicing process. The fibers can be glass fibers or plastic fibers, for example. In order to be able to perform the alignment correctly, it is necessary to evaluate a position of the fibers in the splicing device three-dimensionally. For this purpose it is necessary to use two or more cameras that are arranged accordingly. The video system is also used for identifying fibers in the splicing device. It is likewise possible to perform an optical inspection of fibers, for example with regard to contamination of the fibers, a surface of the end faces of the fibers or an angle of the end faces. Furthermore, an optical inspection of the splicing result can be carried out by the video system. The processes described above can be controlled for example by corresponding software or programs executed on the processor 1.

During the operation of the video system, an image signal is received from a first camera 3 and an image signal is received from a second camera 4. A camera is selected from the first or the second camera 3, 4 depending on a selection signal at the control input 28. The image signal CAM of the selected camera is finally forwarded to the camera interface 11 of the processor 1. In this case, control signals CTRL can also be received from the camera interface and be forwarded to the selected camera. By means of the control signals CTRL, alongside the possibilities described above it is possible to carry out driving of the respectively selected camera and/or to initiate a process of reading out an image from the camera as image signal CAM. A read-out instant or transmission instant of an image recorded by the camera 3, 4 can thus be controlled by one of the control signals CTRL.

Since the selection device 2 can be controlled temporally by means of the selection signal, in contrast to previous solutions it is not necessary in the embodiment of the video system according to the invention to provide clock generation for the selection device 2. A synchronization can be effected for example directly between processor 1 and selected camera 3, 4. Timing problems can thus be reduced or avoided.

The use of the processor 1 with a camera interface 11 integrated on chip makes it possible to provide a splicing device having a video system in accordance with one of the exemplary embodiments with a reduced outlay. By way of example, a video system of this type can be integrated better and requires less space since external synchronization devices and buffer memories for temporarily storing image data can be dispensed with. Furthermore, the use of the processor 1 with an integrated camera interface 11 enables a uniform software interface for image processing.

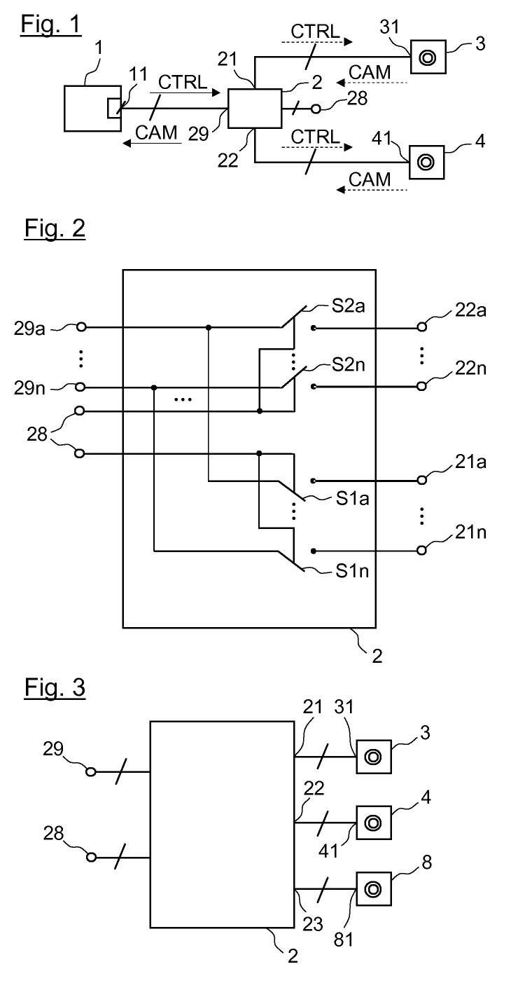

FIG. 2 shows an exemplary embodiment of a selection device 2 that can be used for example in the exemplary embodiment in FIG. 1. The selection device 2 has connections 21a to 21n for the first interface input 21 and also connections 22a to 22n for the second interface input 22. The number of connections 21a to 21n and 22a to 22n depends on the number of data lines for transmitting the image data or the image signal and the number of lines for transmitting the control signals.

Furthermore, connections 29a to 29n for the interface output 29 are provided. The connections 29a to 29n can be coupled to the connections 21a to 21n via switches S1a to S1n, which are switched jointly. Alternatively, the connections 29a to 29n can be coupled to the connections 22a to 22n via switches S2a to S2n. The switches S2a to S2n are also driven jointly. In this case, the driving is effected by means of the selection signal at the control input 28. Consequently, it is possible to transmit image data or image signals CAM or control signals CTRL from and to the connected cameras to and from the camera interface 11 connected to the connections 29a to 29n.

The switches S1a to S1n and also S2a to S2n can be embodied for example by bipolar or field effect transistors or other electronically switchable elements. The function of the selection device 2 can also be formed by a programable logic circuit such as an FPGA. A PLD can also be used as a programable logic circuit.

With the use of an FPGA, however, the latter can be constructed in a very simple manner since, inter alia, there is no need for clock generation for synchronous operation of the selection device 2. In contrast to a conventional solution, it is also not absolutely necessary to provide a memory component for the FPGA in which image data can be buffer-stored, since the image data are transmitted directly from the selected camera to the camera interface 11 integrated on chip. Moreover, the programing complexity for programing the FPGA in operation is reduced. This also leads overall to a lower current consumption of a selection device 2 embodied as an FPGA. Since the data lines and address lines required in the conventional solution for the FPGA can be obviated, the space requirement for the lines on a circuit board also decreases. The adverse effect on the EMC by clock signals is likewise reduced.

FIG. 3 shows an exemplary block diagram of an exemplary embodiment of a selection device 2 with connected cameras. An additional third camera 8 having a connection 81 is provided in the exemplary embodiment. The further camera 8 is connected to a further interface input 23 of the selection device 2. Analogously to the first and second interface inputs 21, 22, the further interface input 23 can also be coupled to the interface output 29 depending on the selection signal at the control input 28. By way of example, a further image signal is received from the camera 8. When selecting a camera depending on the selection signal, it is also possible for the further camera 8 to be selected and for its image signal to be forwarded via the interface output 29 to the camera interface 11 (not shown here) of the processor 1.

As a result, it becomes possible in the splicing device also to evaluate further image data from the observation of fibers to be spliced. In this case, the circuitry outlay in the selection device 2 is increased only to an insignificant extent.

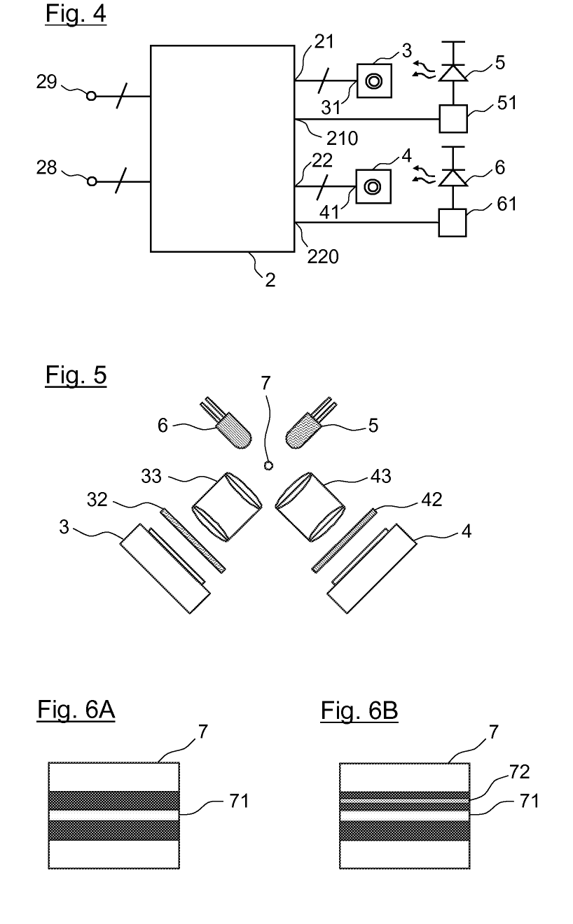

FIG. 4 shows a block diagram of an embodiment of the invention with a selection device 2, cameras 3, 4 and illumination sources 5, 6. A processor 1 with a camera interface 11 is not illustrated in FIG. 4 for reasons of clarity. In the exemplary embodiment, an illumination source 5 is provided for the camera 3 and the illumination source 6 is provided for the camera 4. The illumination sources 5, 6 are embodied as light emitting diodes LED. However, it is also possible to provide other luminous means as illumination sources 5, 6.

The selection device 2 has a first and a second control output 210, 220 for driving the illumination sources 5, 6. In this case, the first control output 210 is coupled to a supply device 51 for the illumination source 5. Analogously to this, the second control output 220 is coupled to a supply device 61 for the illumination source 6. The illumination sources 5, 6 can be switched on and off by means of corresponding signals at the control outputs 210, 220. As a result, it is possible to switch on a respective one of the illumination sources 5, 6 in order to ensure illumination for the respective camera 3, 4. It is possible, therefore, to switch on in each case only the illumination source for the camera selected by means of the selection signal. Consequently, the illumination sources are driven depending on the selection signal for the cameras from which image signals are received.

The supply devices 51, 61 serve for example for a voltage supply or a current supply of the light emitting diodes 5, 6.

FIG. 5 shows an exemplary embodiment of a conventional camera arrangement with illumination sources. In this case, the illumination sources 5, 6 provided are light emitting diodes of different colors, identified by different hatching of the light emitting diodes 5, 6. An optical fiber 7 is illuminated in the arrangement. Lenses 33, 43 for imaging the object, that is to say the optical fiber 7, onto a camera chip area of the cameras 3, 4 and also color filters 32, 42 are furthermore provided. The camera axes of the cameras 3 and 4 preferably lie approximately at a right angle with respect to one another. The color filters 32, 42 only transmit wavelengths in the range of the light from the respective illumination sources 5, 6 of the respective axis. This is identified by corresponding hatching of the color filters 32, 42 for illustration purposes. The use of differently colored light emitting diodes 5, 6 with the corresponding color filters 32, 42 on the two optical axes prevents light from the respective other light emitting diode from producing an image disturbance at the non-associated camera, for example through extraneous light on the chip area of the camera. As a result, the two colored light emitting diodes 5, 6 can remain switched on simultaneously.

FIGS. 6A and 6B show exemplary illustrations of illuminated optical fibers 7. In FIG. 6A, the core of the fiber 7 is illuminated with light 71 as intended, for example through the use of the color filters 32, 42. Without corresponding filtering, the occurrence of extraneous light 72 could happen during the illumination of the fibers 7, as illustrated in FIG. 6B.

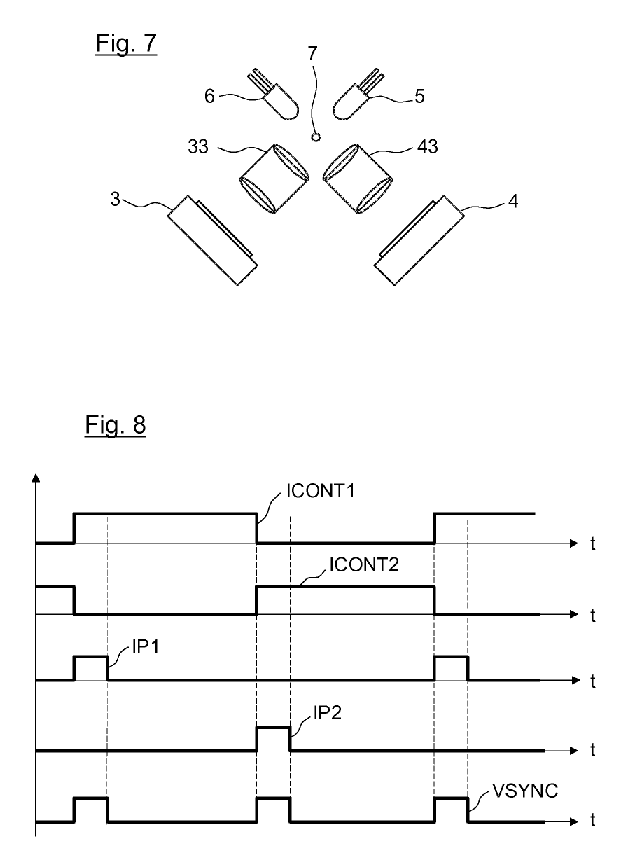

FIG. 7 shows an exemplary embodiment of a camera arrangement with illumination sources. In the solution illustrated, the light emitting diodes 5, 6 are switched on only at points in time required for the cameras 3, 4. By way of example, the light emitting diode 5 is switched on only during the time period of the recording of an image with the camera 3, while the light emitting diode 6 is switched on only during a recording of an image with the camera 4. This prevents the light from the light emitting diode 6 from having a disturbing influence on an image from the camera 3 and the light from the light emitting diode 5 from having a disturbing influence on an image from the camera 4. Moreover, power is saved in the arrangement illustrated by virtue of the illumination source not required being switched off

With the use of the control of the illumination sources, it is thus possible to dispense with color filters and different-colored light emitting diodes or illumination sources. It is therefore also possible to use illumination sources having an identical radiation bandwidth in the optical spectrum. This makes it possible that broadband radiation sources such as white light emitting diodes can also be used and additional costs due to the color filters and differently colored light emitting diodes can be avoided.

The masking out of disturbing reflected light from a non-assigned illumination source is based in this case on a time division multiplex method. Since only the illumination source assigned to the respectively active camera is switched on, no extraneous light can pass into this camera from the second illumination source. The read-out technique of the cameras or camera chips used should be taken into consideration, however, in the driving of the illumination sources.

In the case of cameras having a global shutter, the exposure of all the pixels takes place in the same time period. If this exposure time period has ended, all the pixels of the camera chip become inactive simultaneously. By way of example, the charges generated up to then are transmitted into an optically covered region, for instance in the case of a CCD chip. The simultaneously transmitted pixels therefore represent the image data to be transmitted to the processor. Illumination can be performed in accordance with the exposure time periods of the camera respectively driven.

In the case of cameras having a rolling shutter, a so-called scan line, corresponding to a horizontal image line, runs temporally continuously in a vertical direction over the sensor area or chip area. The pixels of the sensor area which lie on the scan line are read and then reset or erased. The remaining pixels, that is to say both above and below the scan line, are light-sensitive. This should be taken into account in the illumination or the control of the illumination.

Since the chip area is never fully inactive in the case of cameras having a rolling shutter, with continuous illumination the stray light from the respective other light source could also be recorded and leave a disturbing influence at the next individual image read out. Therefore, the control of the illumination of cameras having a rolling shutter is effected in such a way that the image exposure is performed only during a blanking interval of the camera. The illumination is thus effected for the entire image area to be scanned of the respectively selected camera. The image of the respective other camera is not influenced since the image scanned by the other camera in this time period is not transmitted to the camera interface 11 of the processor 1.

According to the principle described, the images of the cameras 3, 4 are forwarded alternately to the processor 1. As a result, an effective halving of the image rate of the individual cameras 3, 4 occurs during the transmission of the image signals since only every second image of a camera is transmitted. An image rate when generating the image signals in the cameras 3, 4 can remain unaffected by this.

FIG. 8 shows an exemplary signal-time diagram for controls of the illumination sources. A signal VSYNC represents a synchronization signal for an image scanning. At a high level of the signal VSYNC, the cameras have a scanning interval during which no scanning of the image takes place.

For the illumination of cameras 3, 4 having a global shutter, signals in accordance with signals ICONT1 and ICONT2 shown in FIG. 8 can be output at the control outputs 210, 220. As a result, the illumination sources 5, 6 are alternately switched on continuously during an exposure time period for the respective camera.

In the case of a camera having a rolling shutter, the signals at the control outputs 210, 220 can correspond to signals IP1 and IP2 shown in FIG. 8. The signals IP1 and IP2 have a high level synchronous with the synchronization signal VSYNC, only in each case every second pulse of the signal VSYNC being mapped onto the signals IP1 and IP2. The synchronization signal VSYNC is essentially identical for both cameras. Scanning of the image with the scan line is effected in the scanning time period succeeding the respective illumination pulse. Since only every second scanned image is actually transmitted to the processor 1, the illumination is thus effected in each case only for the respective image for the respective camera.

The luminous intensity of the illumination sources or light emitting diodes has to be greater in the case of this pulsed illumination than in the case of continuous driving since in the time period of the pulse of the signal VSYNC, the entire light energy required for sufficient exposure should impinge on the sensor or the chip area. Since it is possible, in the case of light emitting diodes, given a corresponding mark-space ratio, to momentarily achieve a significantly higher brightness than nominally specified, such driving can be realized without considerable additional outlay. This is also referred to as an overdriving of the light emitting diode.

With the embodiments described it is possible to realize a driving of two or more cameras with associated illumination control with a low circuitry outlay.

The illumination control described could, however, also be used independently for other illumination scenarios for camera illumination.

Furthermore, for a particularly inexpensive variant of a splicing device, a camera system could be used which has only one camera connected to a processor with the camera interface integrated on chip. A camera system of this type would also have the advantage of not requiring external clock generation in a separate FPGA nor an additional memory for the FPGA. An illumination control could likewise be dispensed with in this case.

Although the present invention has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the present invention and are intended to be covered by the appended claims. It will also be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is

1. A video system for a splicing device, comprising
a processor with a camera interface integrated on chip;
a first and a second camera; and
a selection device, having an interface output, which is coupled to the camera interface, a first interface input, which is coupled to the first camera, a second interface input, which is coupled to the second camera, and a control input for feeding in a selection signal, depending on which the first or the second interface input can be coupled to the interface output;
wherein via the camera interface, it is possible both to receive image data and to output control signals for controlling functions of a camera respectively connected via the selection device.

2. The video system of claim 1, wherein at least one further camera is provided and the selection device has at least one further interface input, which can be coupled to the interface output depending on the selection signal.

3. The video system of claim 1, wherein the sensitivity can be set or an image excerpt can be selected or a rotation or a mirroring of the image excerpt can be selected by means of the control signals at the respectively connected camera.

4. The video system of claim 1, wherein the selection signal can be generated by the processor.

5. The video system of claim 1, wherein the selection device has a first and at least one second control output for driving illumination sources for the connected cameras.

6. The video system of claim 5, wherein the illumination sources are formed by light emitting diodes.

7. The video system of claim 5, wherein the illumination sources are driven in such a way that the illumination sources are in each case switched on during a scanning interval of the respective camera.

8. The video system of claim 1, wherein the selection device is formed by a programmable logic circuit.

9. A method for operating a video system for a splicing device, comprising the steps of:
receiving an image signal from a first camera;
receiving an image signal from a second camera;
selecting a camera from the first or the second camera depending on a selection signal;
forwarding the image signal of the selected camera to a camera interface of a processor, said camera interface being integrated on chip; and
forwarding control signals for controlling functions of the selected camera from the camera interface to the selected camera.

10. The method of claim 9, wherein the sensitivity is set or an image excerpt is selected or rotation or a mirroring of the image excerpt is selected by means of the control signals at the selected camera.

11. The method of claim 9, wherein at least one further image signal is received from an at least one further camera and, when selecting the camera depending on the selection signal, it is also selected from the at least one further camera.

12. The method of claim 9, wherein the selection signal is generated by the processor.

13. The method of claim 9, wherein illumination sources for the cameras from which image signals are received are driven depending on the selection signal.

14. The method of claim 13, wherein, during the driving, the illumination sources are in each case switched on during a scanning interval of the selected camera.
